(19) United States
(12) Patent Application Publication
(10) Pub. No.: US 2025/0208614 A1
(43) Pub. Date: Jun. 26, 2025

(54) MAINTENANCE WORK SUPPORT STATION

(71) Applicant: HITACHI, Ltd., Tokyo (JP)

(72) Inventor: Tsubasa WATANABE, Spring Lake, MI (US)

(21) Appl. No.: 18/392,810

(22) Filed: Dec. 21, 2023

(51) Int. Cl. G05B 23/02

(52) U.S. Cl. CPC G05B 23/0275; G05B 23/0248

(57) ABSTRACT

Systems and methods described herein can involve a maintenance work support system for supporting maintenance work on a machine, which includes management of fault information, cause information, information regarding how to identify cause occurrences, and recovery method information, as fault tree information of the machine; acquiring status information of the machine; processing the status information for one or more of external status information or internal status information; determining a method to identify a cause occurrence of the machine from the processed external status information or the internal status information of the machine; executing the method to determine the cause occurrence of the machine; and displaying the fault tree information of the machine, the acquired status information, and the determined cause occurrence for the machine.

### BACKGROUND

### Field

The present disclosure is generally directed to factory systems, and more specifically, to fault tree management and maintenance management of factory systems.

### Related Art

Maintaining a production line uptime in a factory to maximize productivity is essential. A main factor in loss of line uptime is a machine fault due to some anomaly state. Thus, prompt recovery action is required based on a root cause analysis of the machine fault. For this purpose, a fault tree analysis is commonly performed using a fault tree. The fault tree is a tree diagram containing a top node indicating fault event, a lower node indicating root cause phenomena, and its branch indicating causality of phenomena. The fault tree is effective because the root cause can be immediately determined if the fault is described in the fault tree, thereby eliminating prolonged downtime.

The fault tree focuses on describing the relationship between the phenomenon and the cause. Therefore, the method of confirming whether a cause has occurred by looking at the causes described in the fault tree and the determination of the cause itself is left to an operator. Therefore, problems have arisen in which non-skilled operators take too much time to identify the root cause even if a fault tree exists. Other problems have also included misdiagnosis, or failure to identify the root cause even after spending significant time.

In the related art, there can be a system that supports the maintenance work involved in analyzing equipment failures by using a diagnostic tree that has similar performance to a fault tree. In such a related art system, the diagnosis tree is not simply used to search for each path in the diagnosis tree, but is also used to optimize the search path using the estimated cost of tracing each path from using information regarding required preparation work time and maintenance work time recorded at each node as well as the past probability of occurrence to efficiently support the analysis of equipment failure.

### SUMMARY

There is a need for a maintenance work support system that can facilitate root cause identification using fault trees, even by unskilled operators. The related art systems can support efficient maintenance work by performing route optimization based on information pre-installed in the diagnostic tree, but as a precondition, the workers must be at a level where they can perform the work necessary to identify the cause and make decisions related to the identification of the cause. Therefore, non-skilled workers may not be able to execute the optimal route even if it is presented.

Based on the above issue, the example implementations described herein involve a system that can reduce the number of operator-dependent processes as well as reduce the probability of a misdiagnosis. Example implementations described herein can involve separating the work to identify the cause of a fault tree or diagnosis tree into pre-work, so as to eliminate the need of information gathering and judgment based on device knowledge and experience.

In example implementations described herein, the maintenance work support system for supporting a maintenance work of a machine has a recording unit that records fault information, cause information, information on how to identify the cause occurrences, and recovery method information (e.g., fault tree information of the machine) and a status acquisition, and a processing unit for processing the acquired state information. A display unit can be used for displaying the fault tree information, the machine status acquisition method information, the acquired status information, the cause occurrence information based on the status, and the recovery method information. The method of identifying the cause occurrence involves a method of identifying the cause by either the external status information or the internal status information of the machine and the cause occurrence is judged from such information.

Such a maintenance work support system can also use video or images acquired by the camera as one of the external status information is input to the processing section as the external status information, and the judgment result on the cause occurrence is obtained as the output of the processing unit.

Such a maintenance work support system can also use information on how to identify the cause occurrences, which contains a necessity and contents of pre-work to be performed before status collection, and the external or internal status information to be used for judging the completion of pre-work.

Such a maintenance work support system can also start status collection to identify the cause occurrences by the external or internal status information, which is used for judging pre-work completion.

Such a maintenance work support system can also execute such that one of the status information used to judge pre-work completion differs from the status information type used to identify the cause occurrences.

Aspects of the present disclosure can involve a maintenance work support system for supporting maintenance work on a machine, which can involve a memory, configured to manage fault information, cause information, information regarding how to identify cause occurrences, and recovery method information, as fault tree information of the machine; an interface configured to acquire status information of the machine; and a processor configured to, process the status information for one or more of external status information or internal status information; determine a method to identify a cause occurrence of the machine from the processed external status information or the internal status information of the machine; execute the method to determine the cause occurrence of the machine; and display the fault tree information of the machine, the acquired status information, and the determined cause occurrence for the machine.

Aspects of the present disclosure can involve a method, which can involve managing fault information, cause information, information regarding how to identify cause occurrences, and recovery method information, as fault tree information of the machine; acquiring status information of the machine; processing the status information for one or more of external status information or internal status information; determining a method to identify a cause occurrence of the machine from the processed external status information or the internal status information of the machine; executing the method to determine the cause occurrence of the machine; and displaying the fault tree information of the machine, the acquired status information, and the determined cause occurrence for the machine.

Aspects of the present disclosure can involve a computer program, which can involve instructions including managing fault information, cause information, information regarding how to identify cause occurrences, and recovery method information, as fault tree information of the machine; acquiring status information of the machine; processing the status information for one or more of external status information or internal status information; determining a method to identify a cause occurrence of the machine from the processed external status information or the internal status information of the machine; executing the method to determine the cause occurrence of the machine; and displaying the fault tree information of the machine, the acquired status information, and the determined cause occurrence for the machine. The computer instructions and program can be stored on a non-transitory computer readable medium and executed by one or more processors.

Aspects of the present disclosure can involve a system, which can involve means for managing fault information, cause information, information regarding how to identify cause occurrences, and recovery method information, as fault tree information of the machine; means for acquiring status information of the machine; means for processing the status information for one or more of external status information or internal status information; means for determining a method to identify a cause occurrence of the machine from the processed external status information or the internal status information of the machine; means for executing the method to determine the cause occurrence of the machine; and means for displaying the fault tree information of the machine, the acquired status information, and the determined cause occurrence for the machine.

### BRIEF DESCRIPTION OF DRAWINGS

FIG. 1 illustrates an example architecture of a related art maintenance work support system.

FIG. 2 illustrates an example of the minimum relationship of the fault tree in the related art.

FIG. 3 illustrates a related art example of a fault tree diagram that exists in the recording unit as fault tree information.

FIG. 4 illustrates a related art example of detailed information on how to identify the cause occurrences.

FIG. 5 illustrates a related art flow chart of the related art maintenance work support system.

FIG. 6 illustrates a maintenance work support system in accordance with an example implementation.

FIG. 7 illustrates examples of information regarding how to identify cause occurrences, in accordance with an example implementation.

FIG. 8 illustrates a partial example of a fault tree, in accordance with an example implementation.

FIG. 9 illustrates an example flow diagram of the maintenance work support system, in accordance with an example implementation.

FIG. 10 illustrates another example architecture of the maintenance work support system, in accordance with an example implementation.

FIG. 11 illustrates an example of information regarding how to identify cause occurrence, in accordance with an example implementation.

FIG. 12 illustrates an example fault tree diagram involving a completion check, in accordance with an example implementation.

FIG. 13 illustrates another example flowchart of the maintenance work support system involving a completion check, in accordance with an example implementation.

FIG. 14 illustrates an example of identifying cause occurrences through involving pre-work completion check, in accordance with an example implementation.

FIG. 15 illustrates a plurality of physical systems that are networked to a management apparatus, in accordance with an example implementation.

FIG. 16 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented in any manner in accordance with the desired implementation.

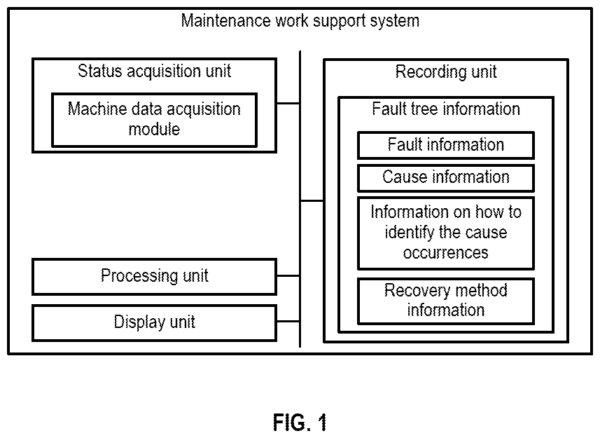

FIG. 1 illustrates an example architecture of a related art maintenance work support system. Specifically, the example systems utilize machine data to identify the root cause through utilizing the fault tree and based on the machine data that is acquired.

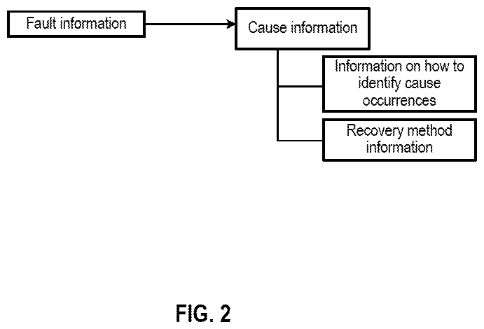

FIG. 2 illustrates an example of the minimum relationship of the fault tree in the related art. At the core of the fault tree is a direct relationship between the fault and the cause. Other information, such as how to identify cause occurrences and recovery methods, is added to support unskilled technicians. Recovery method information is only added if the cause is the root cause (the final node of the fault tree).

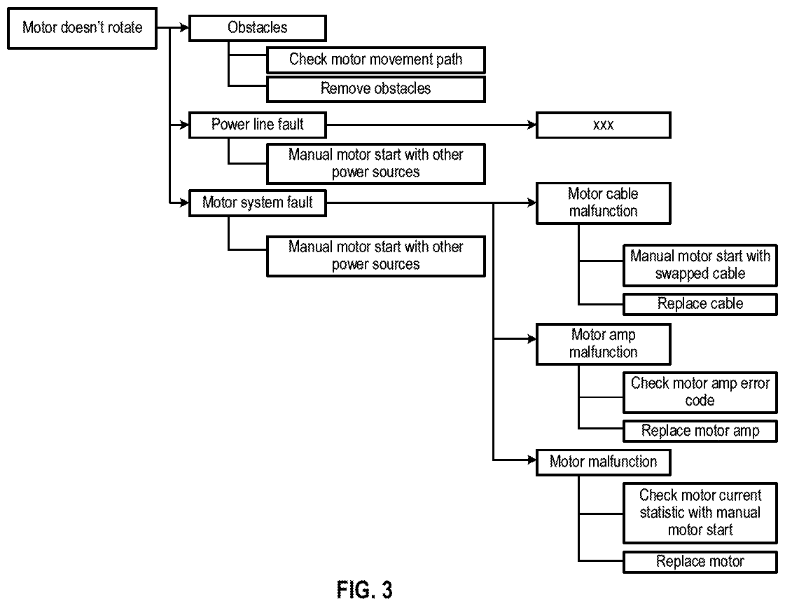

FIG. 3 illustrates a related art example of a fault tree diagram that exists in the recording unit as fault tree information. As illustrated in FIG. 3, the fault tree diagram can involve information including a narrative for a fault symptom, narrative for type of fault, and a narrative for recommendation to overcome the fault. In this example fault tree, each node is an example of a cause of the occurrence, wherein the final node will have recovery information. For example, the node “Obstacles” has a recovery method of “check motor movement path” and “remove obstacles”. If it is an intermediate cause or fault (e.g., “Motor system fault”) then there are also lower level nodes that can exist in the tree. For example, if “Motor cable malfunction” is the last node, it can be determined to be the root cause of the fault, and the recovery method can involve “Manual motor start with swapped cable” and “Replace cable”.

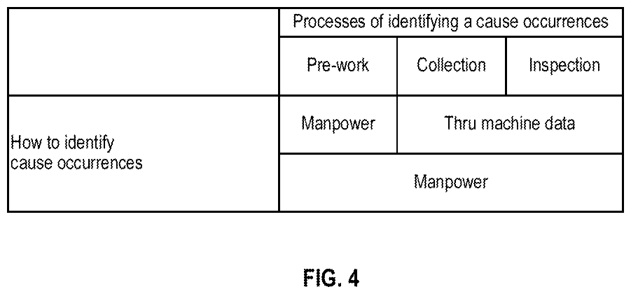

FIG. 4 illustrates a related art example of detailed information on how to identify the cause occurrences. Specifically, FIG. 4 illustrates a procedure for each case. To confirm the machine status, machine data or manual observation is obtained. There are three steps in identifying the cause occurrence. There is pre-work, collection, and inspection. Pre-work involves work that is required to conduct the collection and inspection (e.g., need to open the door of the machine to inspect the machine internally). Collection involves the collection of data (e.g., from internal mechanisms of the machine, from observation by the technician). Inspection refers to the inspection based on the data collection (e.g., traversing the fault tree from internal status, technician observing whether there are burns or other damage indicia in the machine after opening the door).

For internal status, there are sensor data or other control/feedback systems for the machine that can provide the internal status of the machine, which is collected and then used for the inspection from mapping the data to the fault tree. However, for the external status, the related art systems rely solely on manual work for collection and inspection, the judgment of which will rely solely on the engineer or technician making the observations and their corresponding skill level.

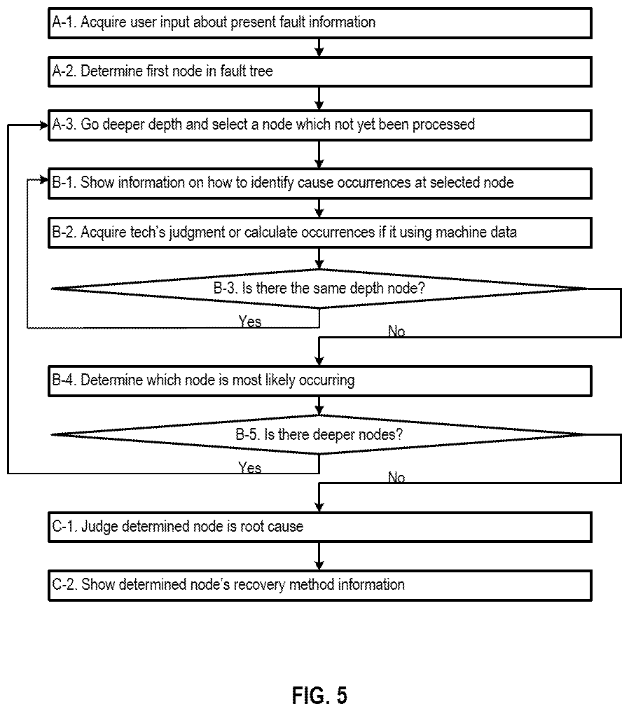

FIG. 5 illustrates a related art flow chart of the related art maintenance work support system. In the related art example, the system traces the fault tree diagram from the top node by performing cause occurrence identification. The display unit shows each piece of information during tracing, and once the root cause is reached, the recovery method information is shown as a final step. As shown in FIG. 5, although the flow can calculate the occurrences if machine (internal status) data is used, with regards to the external status, the judgment of the technician is manually required to determine the traversal of the fault tree as shown at B-2. Accordingly, the flow of the related art is reliant on the skill of the technician.

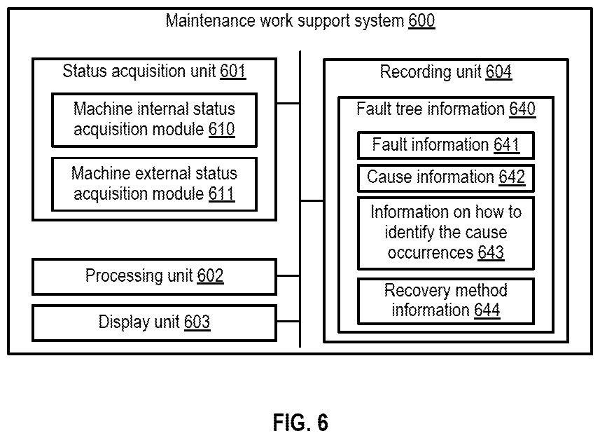

FIG. 6 illustrates a maintenance work support system in accordance with an example implementation. The difference between the related art examples is status information acquired as internal or external status information based on how to identify cause occurrences. The identifying process is separated as pre-work and collection/inspection.

In the example maintenance work support system 600, there is a status acquisition unit 601, a processing unit 602, a display unit 603, and a recording unit 604. In contrast to the related art implementation, the status acquisition unit 601 can include a machine internal status acquisition module 610 and a machine external status acquisition module 611. The recording unit 604 can have fault tree information 640 which can include fault information 641, cause information 642, information on how to identify the cause occurrences 643, and recovery method information 644.

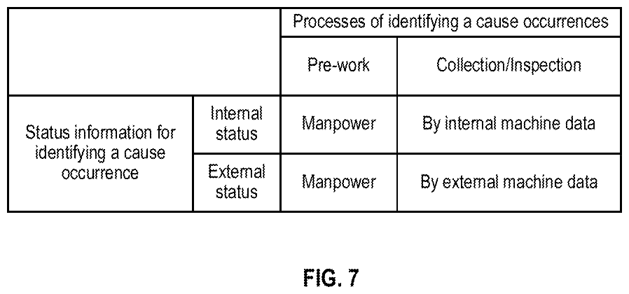

FIG. 7 illustrates examples of information regarding how to identify cause occurrences 643, in accordance with an example implementation. In this example, status information for identifying a cause occurrence can be based on internal status or external status of the machine. Processes for identifying the cause occurrences can be separated as pre-work and collection/inspection. In this example, all of the pre-work information involves manual information, but the collection/inspection information is obtained from either internal machine data or external machine data. Examples of internal machine data can include, but is not limited to, programmable logic controller (PLC) bit, machine alarm, controller feedback values, and so on.

Examples of external machine data can include, but are not limited to, pictures, movies, environmental sensors such as sound, vibration, load, temperature, humidity sensors, images or video of the machine captured from cameras focused on the machine, and so on. Accordingly, the example implementations place a separation between internal status versus external status, and conducts an automated judgment based on at least one of the statuses.

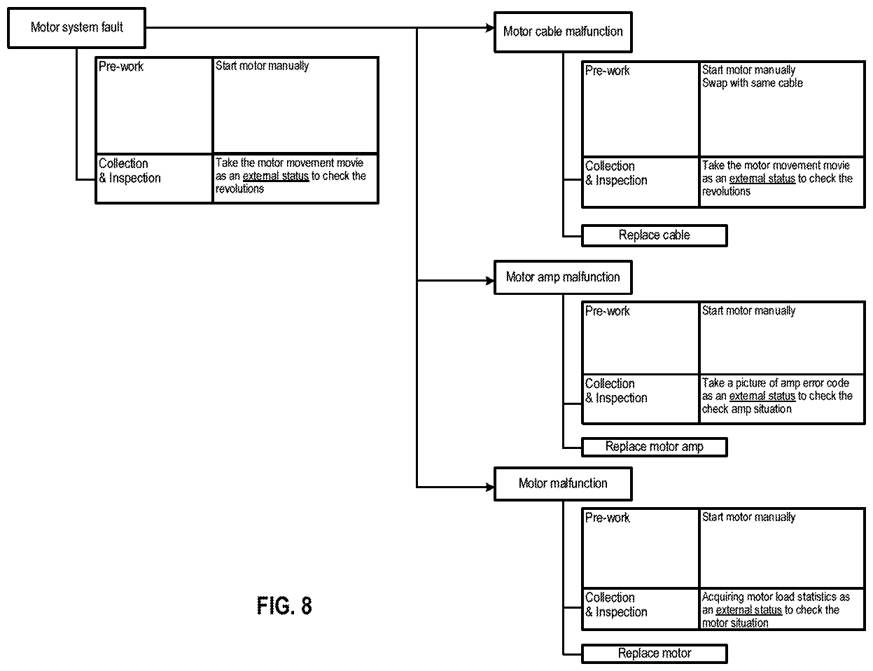

FIG. 8 illustrates a partial example of a fault tree 640, in accordance with an example implementation. For example, for a motor system fault, the fault tree requires pre-work of a worker to start the motor manually. The collection/inspection involves taking the motor movement video (e.g., via a camera focused on the motor) as external status to check the revolutions of the motor. The fault tree can also include recovery method information, as shown for example in “Replace cable” in response to a motor cable malfunction.

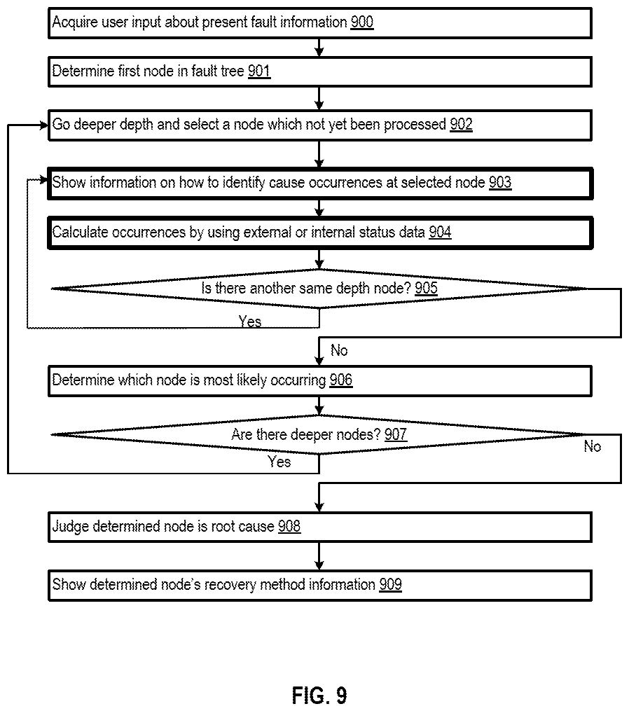

FIG. 9 illustrates an example flow diagram of the maintenance work support system, in accordance with an example implementation.

At 900, the flow acquires user input regarding the present fault information. At 901, the flow determines the first node in the fault tree. At 902, the flow traverses the depth of the fault tree and selects a node that has not yet been processed.

At 903, the flow provides the information (e.g., to display unit 603) on how to identify the cause occurrences at the selected node. At 904, the flow then calculates the occurrences by using the external or internal status data. The flow differs from the related art example in that the flow can be automated and the judgment from the technician can thereby be avoided, thereby making the traversal of the fault tree to identify the root cause to be independent from the skill level of the technician.

At 905, a determination is made as to whether there is another node at the same depth. If so (Yes), then the flow proceeds to 903 to process that node, otherwise (No) the flow proceeds to 906.

At 906, a determination is made as to which node is most likely occurring for the given event. At 907, a determination is made as to whether there are deeper nodes to traverse in the fault tree. If so (Yes), then the flow proceeds to 902 to traverse the depth of the fault tree to the next level, otherwise (No) the flow proceeds to 908 to judge that the determined node is the root cause for the event. At 909, the recovery method information associated with that node is provided (e.g., to display unit 603).

Through the example implementations described above, unskilled workers do not need to judge the underlying cause of an event by themselves because the inspection can be done automatically through collected internal or external information, thereby preventing misjudgment of the event.

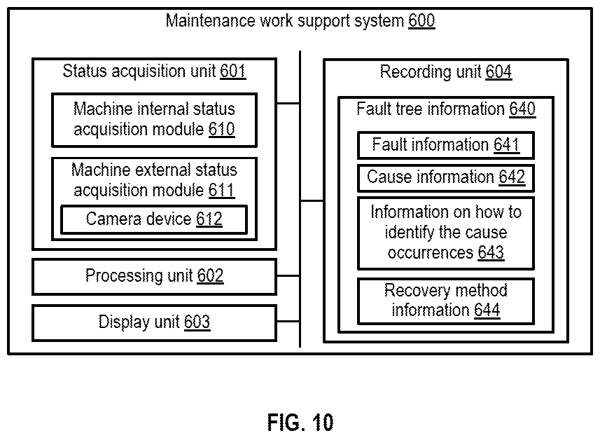

FIG. 10 illustrates another example architecture of the maintenance work support system, in accordance with an example implementation. In this example architecture, a camera device 612 can be utilized by the machine external status acquisition module 611 to provide and process pictures or movies to identify the cause occurrence.

Through the use of camera devices 612 in the system and through processing the acquired data in the processing unit 602, the system can thereby automatically inspect the cause occurrence. Further, the system can eliminate the amount of storage consumed by the system by directly processing the picture and/or movie data, which may otherwise cause a system delay and requirement more storage space for processing.

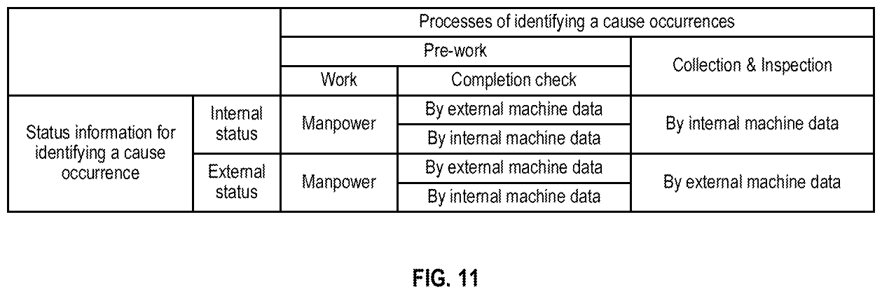

FIG. 11 illustrates an example of information regarding how to identify cause occurrence, in accordance with an example implementation. As illustrated in FIG. 7, oftentimes the pre-work is still conducted manually, which may also rely on the skill of the technician conducting the pre-work, thereby introducing the possibility of human error. In this example, an automated pre-work completion check is utilized to prevent a misdiagnosis, and is verified through the internal machine data or the external machine data. The completion check can be determined by external machine data or by internal machine data so as to reduce the possibility of missed work or human error in the pre-work process.

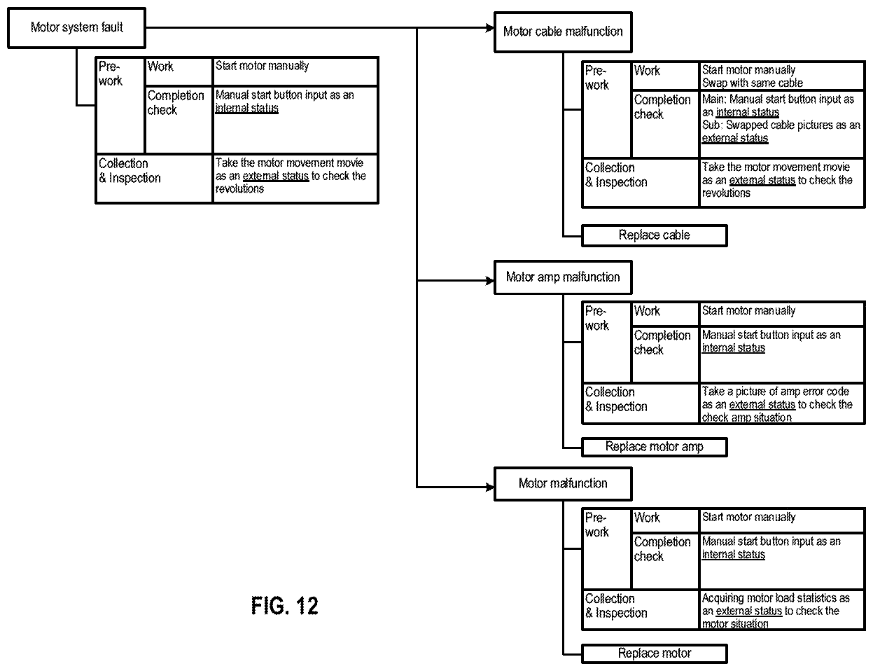

FIG. 12 illustrates an example fault tree diagram involving a completion check, in accordance with an example implementation. As shown in the example fault tree diagrams of FIG. 12, a completion check requirement for “Motor system fault” can involve receiving a manual start button input as an internal status to start the motor manually. In another example for the fault of a motor cable malfunction, the completion check can also involve pictures of the swapped cable as external status information for the completion check. Through such an example implementation, the reduction of human error can thereby be achieved.

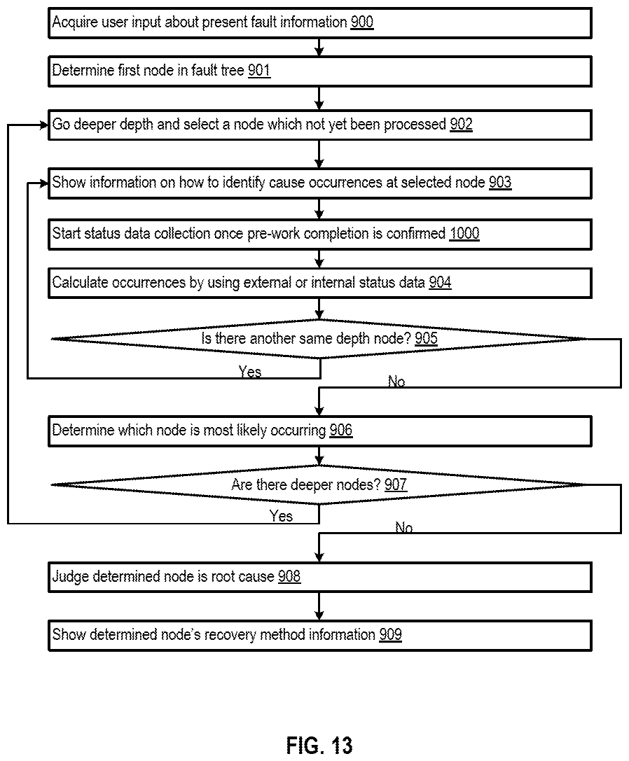

FIG. 13 illustrates another example flowchart of the maintenance work support system involving a completion check, in accordance with an example implementation. The difference between the 3rd example is that a pre-work completion check is used as a data collection trigger to prevent misdiagnosis, as illustrated at the flow at 1000.

Applying a completion check through utilizing internal or external status data prevents two different misdiagnosis possibilities. In a first misdiagnosis possibility, the worker/technician may need to push some button at the touch panel, such as for a motor system fault. With a touch panel, it is sometimes hard to identify whether the technician pushed the button correctly, so sometimes the technician may come to believe that the target system is not working correctly, even if the fault is caused by not pushing the button. In a second misdiagnosis possibility, it is possible that data collection, such as motor malfunction, must be conducted after the pre-work is completed. In such an example, the required motor current statistics include the motor current rise when the motor rotation starts, so the system cannot acquire data if the data collection is started manually.

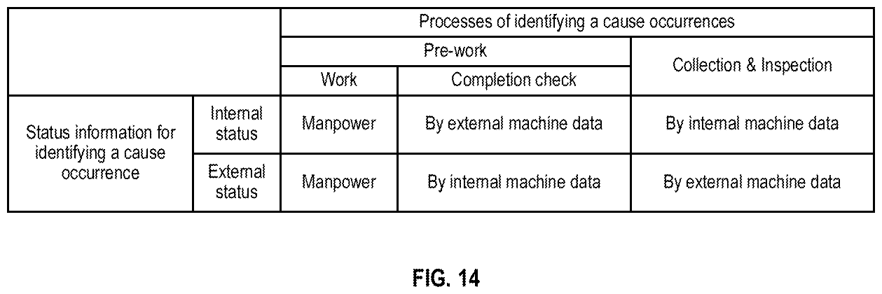

FIG. 14 illustrates an example of identifying cause occurrences through involving pre-work completion check, in accordance with an example implementation. The example of FIG. 14 illustrates a main combination of data sources for inspection and the pre-work completion check. The data source for each is set as opposite (e.g., completion check by external machine data, collection/inspection by internal machine data), which is also reflected in the fault tree as illustrated in FIG. 12. Applying such a combination can eliminate some faults related specifically to the internal status or external status, such as acquisition system failure or device failure.

In particular for electrical systems, internal data for pre-work completion check and external data for inspection can serve as an effective combination in a fault tree such as shown in FIG. 12, as electrical fault may be difficult to confirm internally.

Example implementations described herein involves a fault tree in which the information needed to identify the cause is categorized into pre-work and internal or external status collection and inspection. This allows the system to automate the external status collection and inspection using image judgment to prevent misdiagnosis caused by unskilled workers and to use the completion signal as a trigger for the collection of pre-work to prevent implementation errors in the pre-work.

By using this system, the work required to identify the root cause of a failure can be performed by unskilled workers, and a misdiagnosis can be reduced. This eliminates the need for equipment manufacturers to have their own skilled technicians to perform maintenance and also eliminates the need to set up a maintenance center near the installation site, even if the equipment is installed in an area far from the installation site, thereby reducing support costs.

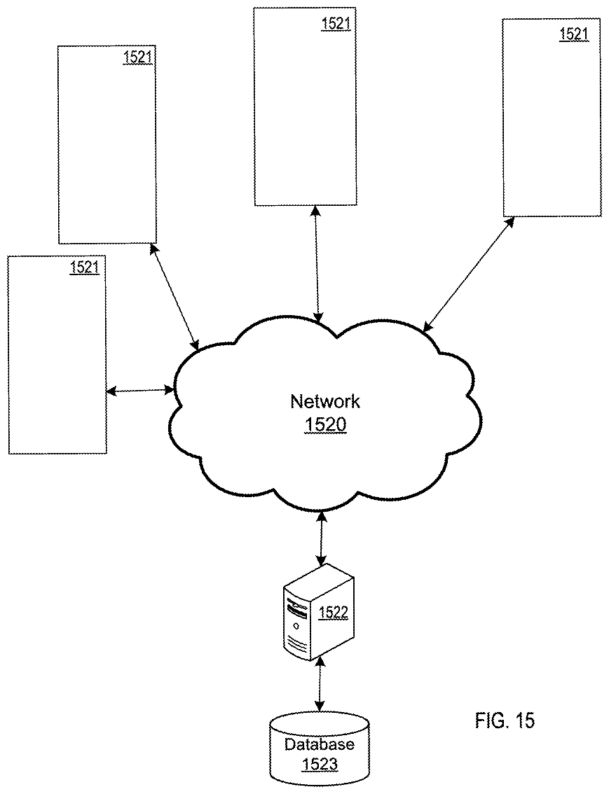

FIG. 15 illustrates a plurality of physical systems that are networked to a management apparatus, in accordance with an example implementation. One or more physical systems 1521 (e.g., air compressors, lathes, server systems, etc.) involve physical machines that are communicatively coupled to a network 1520 (e.g., local area network (LAN), wide area network (WAN)) through the corresponding network interface of the sensor system installed in the physical systems 1521, which is connected to a management apparatus 1522 configured to facilitate the functionality of the maintenance work support system 600 for supporting maintenance work on a machine of the physical systems 1521. The one or more systems 1521 may or may not be associated with sensors, depending on the desired implementation. The management apparatus 1522 manages a database 1523, which contains historical data collected from the sensor systems from each of the physical systems 1521. In alternate example implementations, the data from the sensor systems of the physical systems 1521 can be stored in a central repository or central database such as proprietary databases that intake data from the physical systems 1521, or systems such as enterprise resource planning systems, and the management apparatus 1522 can access or retrieve the data from the central repository or central database. The sensor systems of the physical systems 1521 can include any type of sensors to facilitate the desired implementation and provide internal status machine data, such as but not limited to gyroscopes, accelerometers, global positioning satellite (GPS), thermometers, humidity gauges, or any sensors, and so on. As described herein, the management apparatus 1522 can also be connected to one or more cameras (not illustrated) that are monitoring the external status of the machines of the one or more physical systems 1521.

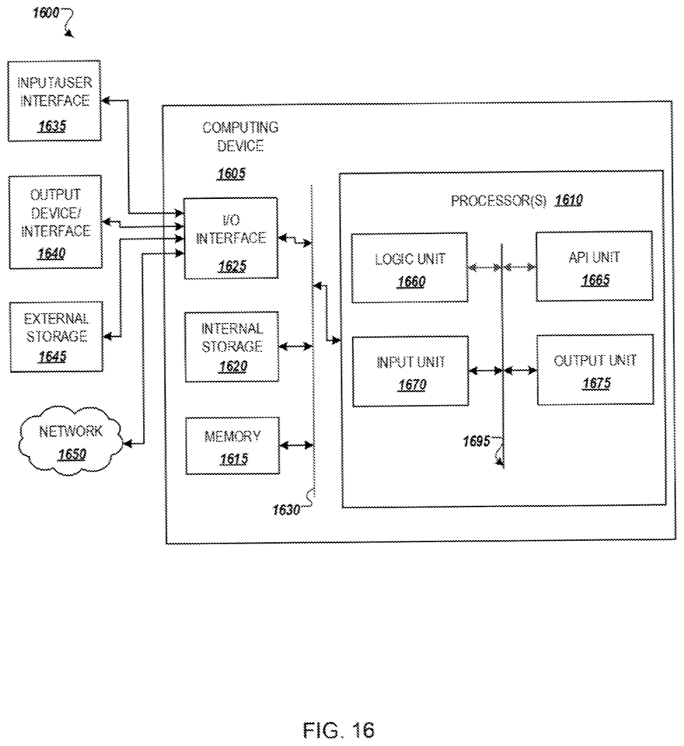

FIG. 16 illustrates an example computing environment with an example computer device suitable for use in some example implementations, such as the management apparatus 1522 to facilitate the functionality of the maintenance work support system 600. Computer device 1605 in computing environment 1600 can include one or more processing units, cores, or processors 1610, memory 1615 (e.g., RAM, ROM, and/or the like), internal storage 1620 (e.g., magnetic, optical, solid state storage, and/or organic), and/or I/O interface 1625, any of which can be coupled on a communication mechanism or bus 1630 for communicating information or embedded in the computer device 1605. I/O interface 1625 is also configured to receive images from cameras or provide images to projectors or displays, depending on the desired implementation.

Computer device 1605 can be communicatively coupled to input/user interface 1635 and output device/interface 1640. Either one or both of input/user interface 1635 and output device/interface 1640 can be a wired or wireless interface and can be detachable. Input/user interface 1635 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1640 may include a display, television, monitor, printer, speaker, braille, or the like. In some example implementations, input/user interface 1635 and output device/interface 1640 can be embedded with or physically coupled to the computer device 1605. In other example implementations, other computer devices may function as or provide the functions of input/user interface 1635 and output device/interface 1640 for a computer device 1605.

Examples of computer device 1605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1605 can be communicatively coupled (e.g., via I/O interface 1625) to external storage 1645 and network 1650 for communicating with any number of networked components, devices, and systems, including one or more computer devices of the same or different configuration. Computer device 1605 or any connected computer device can be functioning as, providing services of, or referred to as a server, client, thin server, general machine, special-purpose machine, or another label.

I/O interface 1625 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1600. Network 1650 can be any network or combination of networks (e.g., the Internet, local area network, wide area network, a telephonic network, a cellular network, satellite network, and the like).

Computer device 1605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1610 can execute under any operating system (OS) (not shown), in a native or virtual environment. One or more applications can be deployed that include logic unit 1660, application programming interface (API) unit 1665, input unit 1670, output unit 1675, and inter-unit communication mechanism 1695 for the different units to communicate with each other, with the OS, and with other applications (not shown). The described units and elements can be varied in design, function, configuration, or implementation and are not limited to the descriptions provided. Processor(s) 1610 can be in the form of hardware processors such as central processing units (CPUs) or in a combination of hardware and software units.

In some example implementations, when information or an execution instruction is received by API unit 1665, it may be communicated to one or more other units (e.g., logic unit 1660, input unit 1670, output unit 1675). In some instances, logic unit 1660 may be configured to control the information flow among the units and direct the services provided by API unit 1665, input unit 1670, output unit 1675, in some example implementations described above. For example, the flow of one or more processes or implementations may be controlled by logic unit 1660 alone or in conjunction with API unit 1665. The input unit 1670 may be configured to obtain input for the calculations described in the example implementations, and the output unit 1675 may be configured to provide output based on the calculations described in example implementations.

Memory 1615 can be configured to facilitate the functionality of the recording unit 604, which can be configured to a memory, configured to manage fault information 641, cause information 642, information regarding how to identify cause occurrences 643, and recovery method information 644, as fault tree information of the machine as illustrated in FIGS. 8 and 12.

I/O interface 1625 can be configured to acquire the status information (e.g., external status or internal status) of a machine in the physical systems 1521.

Processor(s) 1610 can be configured to process the status information for one or more of external status information or internal status information (e.g., depending on what has been received); determine a method to identify a cause occurrence of the machine from the processed external status information or the internal status information of the machine (e.g., through referencing collection/inspection information as illustrated in FIGS. 7, 11, and 14 and as illustrated at 903, 904 of FIGS. 9 and 13); execute the method to determine the cause occurrence of the machine; and display the fault tree information of the machine, the acquired status information, and the determined cause occurrence for the machine as illustrated at FIG. 8 and FIG. 12.

Depending on the desired implementation, a camera can also be connected to the I/O interface 1625, wherein the external status information comprises video or images of the machine captured by the camera of the machine, wherein the method to identify the cause occurrence of the machine is based on the external status information.

Processor(s) 1610 can be configured to execute the method and instructions as described above, and be further configured to determine the method to identify the cause occurrence based on the information regarding how to identify the cause occurrence, the information regarding how to identify the cause occurrence comprising information regarding pre-work to be performed before status collection, and the external status information or the internal status information to be used to determine the completion of the pre-work as illustrated at FIG. 11.

Processor(s) 1610 can be configured to execute the method and instructions as described above, wherein the processor 1610 is configured to control the interface 1625 to acquire the status information of the machine to determine the method to identify the cause occurrence of the machine, wherein the processor 1610 executes the method to determine the cause occurrence of the machine and determines the completion of the pre-work based on the output cause occurrences from the execution of the method as described with respect to FIG. 12 to FIG. 14.

Depending on the desired implementation, the status information can be used to determine the completion of the pre-work is differs from the status information used to determine the method to identify the cause occurrences as illustrated in FIG. 14 (e.g., completion check is verified by the opposite machine data in comparison to the collection/inspection).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored in the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A maintenance work support system for supporting maintenance work on a machine, comprising:
a memory, configured to:
manage fault information, cause information, information regarding how to identify cause occurrences, and recovery method information, as fault tree information of the machine;
an interface configured to acquire status information of the machine; and
a processor configured to:
process the status information for one or more of external status information or internal status information;
determine a method to identify a cause occurrence of the machine from the processed external status information or the internal status information of the machine;
execute the method to determine the cause occurrences of the machine; and
display the fault tree information of the machine, the acquired status information, and the determined cause occurrence for the machine.

2. The maintenance work support system of claim 1, further comprising a camera connected to the interface, wherein the external status information comprises video or images of the machine captured by the camera of the machine, wherein the method to identify the cause occurrence of the machine is based on the external status information.

3. The maintenance work support system of claim 1, wherein the processor is configured to determine the method to identify the cause occurrence based on the information regarding how to identify the cause occurrence, the information regarding how to identify the cause occurrence comprising information regarding pre-work to be performed before status collection, and the external status information or the internal status information to be used to determine completion of the pre-work.

4. The maintenance work support system of claim 3, wherein the processor is configured to control the interface to acquire the status information of the machine to determine the method to identify the cause occurrence of the machine, wherein the processor executes the method to determine the cause occurrence of the machine and determines the completion of the pre-work based on the cause occurrences from the execution of the method.

5. The maintenance work support system of claim 3, where the status information used to determine the completion of the pre-work is differs from the status information used to determine the method to identify the cause occurrences.

6. A method for supporting maintenance work on a machine, comprising:
managing fault information, cause information, information regarding how to identify cause occurrences, and recovery method information, as fault tree information of the machine;
acquiring status information of the machine;
processing the status information for one or more of external status information or internal status information;
determining a method to identify a cause occurrence of the machine from the processed external status information or the internal status information of the machine;
executing the method to determine the cause occurrences of the machine; and
displaying the fault tree information of the machine, the acquired status information, and the determined cause occurrence for the machine.

7. The method of claim 6 wherein the external status information comprises video or images of the machine captured by a camera of the machine, wherein the method to identify the cause occurrence of the machine is based on the external status information.

8. The method of claim 6, wherein the determining the method to identify the cause occurrence based on the information regarding how to identify the cause occurrence, the information regarding how to identify the cause occurrence comprising information regarding pre-work to be performed before status collection, and the external status information or the internal status information to be used to determine completion of the pre-work.

9. The method of claim 8, wherein the status information of the machine is utilized to determine the method to identify the cause occurrence of the machine, wherein the method to determine the cause occurrence of the machine is executed to determine the completion of the pre-work based on the cause occurrences from the execution of the method.

10. The method of claim 8, where the status information used to determine the completion of the pre-work is differs from the status information used to determine the method to identify the cause occurrences.

11. A non-transitory computer readable medium, storing instructions for supporting maintenance work on a machine, the instructions comprising:
managing fault information, cause information, information regarding how to identify cause occurrences, and recovery method information, as fault tree information of the machine;
acquiring status information of the machine;
processing the status information for one or more of external status information or internal status information;
determining a method to identify a cause occurrence of the machine from the processed external status information or the internal status information of the machine;
executing the method to determine the cause occurrences of the machine; and
displaying the fault tree information of the machine, the acquired status information, and the determined cause occurrence for the machine.

12. The non-transitory computer readable medium of claim 11, wherein the external status information comprises video or images of the machine captured by a camera of the machine, wherein the method to identify the cause occurrence of the machine is based on the external status information.

13. The non-transitory computer readable medium of claim 11, wherein the determining the method to identify the cause occurrence based on the information regarding how to identify the cause occurrence, the information regarding how to identify the cause occurrence comprising information regarding pre-work to be performed before status collection, and the external status information or the internal status information to be used to determine completion of the pre-work.

14. The non-transitory computer readable medium of claim 13, wherein the status information of the machine is utilized to determine the method to identify the cause occurrence of the machine, wherein the method to determine the cause occurrence of the machine is executed to determine the completion of the pre-work based on the cause occurrences from the execution of the method.

15. The non-transitory computer readable medium of claim 13, where the status information used to determine the completion of the pre-work is differs from the status information used to determine the method to identify the cause occurrences.
